(19) United States
(12) Patent Application Publication
(10) Pub. No.: US 2015/0254754 A1
(43) Pub. Date: Sep. 10, 2015

(54) METHODS AND APPARATUSES FOR CONSUMER EVALUATION OF INSURANCE OPTIONS

(71) Applicant: Stride Health, Inc., San Francisco, CA (US)

(72) Inventors: Noah B. Lang, San Francisco, CA (US); Matthew C. Butner, San Francisco, CA (US)

(21) Appl. No.: 14/642,725

(22) Filed: Mar. 9, 2015

Related U.S. Application Data
(60) Provisional application No. 61/949,963, filed on Mar. 7, 2014.

(51) Int. Cl. G06Q 30/06

(52) U.S. Cl. CPC G06Q 30/0631; G06Q 40/08

(57) ABSTRACT

Methods, systems and apparatus are provided for recommending health insurance plans. Data inputs are received from a graphical user interface. These inputs may include data about location, gender, age, health conditions, prescription drugs and smoking habits. A subset of available health insurance plans is determined. A second database is queried for information about health care events and/or costs of people that match a subset of the user data inputs. Care costs are calculated for each health insurance plan by simulating the health events of the similar people returned from the second database under each health care plan. A total cost of ownership for each health insurance plan is calculated by adding monthly premiums for each health insurance plan to the care costs for that plan. A health insurance plan recommendation is made based at least in part and sometimes exclusively on the total cost of ownership.

### RELATED APPLICATIONS

This application claims the benefit of U.S. Provisional Patent Application No. 61/949,963, filed Mar. 7, 2014, and titled “METHODS AND APPARATUSES FOR CONSUMER EVALUATION OF INSURANCE OPTIONS,” which is incorporated herein in its entirety by reference.

### FIELD

The present patent document relates to systems, methods and apparatuses for consumer evaluation of insurance options. More particularly, the present patent document relates to systems, methods and apparatuses to allow consumers to evaluate, compare and choose between various health insurance plans.

### BACKGROUND

To date, there has been no effective means for an average consumer to evaluate health insurance plans, which feature highly variable coverage options with respect to copay percentages, out-of-pocket cost limitations, deductibles, and provider networks as well as other financial metrics. Though health insurance plans have been recently segmented into tiers by the Affordable Care Act, information about those plans' particular benefits and costs has been available only in disparate format and with variable levels of transparency, making a comparison of total costs over a specified time period (both guaranteed and prospective) immensely difficult. To this end, there is a need for an efficient way to provide a consumer with an answer to the question: Which available health insurance plan will help me with the care I want or need for the lowest total cost?

With the recent passage of the Affordable Care Act (the “Act”), health insurance pricing is constrained by a limited number of pricing factors, and it has become feasible and desirable to allow consumers to obtain definitive prices for health insurance coverage prior to any personalized application.

Existing solutions do not allow the user to select from a broad range of health plans (e.g., U.S. Pat. Nos. 8,407,064; 7,426,474; and US 2006/0248008). In some cases, existing solutions impose an obligation on the user to pre-select a health plan that already covers the user or that the user believes will be desirable prior to evaluating its benefits (e.g., US 2013/0090943).

Existing solutions for insurance selection have many drawbacks including: requiring copious and time-consuming user participation, which is subject to user error (e.g. U.S. Pat. No. 8,442,847), are customized solely for projecting contributions to a type of health/flexible saving account (U.S. Pat. No. 8,407,064), or require reference to data about filed claims (e.g., U.S. Pat. No. 6,735,569), purchased medications or undertaken procedures (e.g., U.S. Pat. Nos. 7,444,291; 7,426,474; 5,724,379; US 2005/0261939; PCT/US2012/058855; PCT/US2012/0022898). All such modeling has been dependent upon the entry of at least some historical information about or by a patient, which may be prone to errors and which may or may not accurately predict an individual's future health care needs. In addition, the collection of such historical information creates a privacy risk to end-users without express protections. Moreover, previous cost modeling that has been based upon user inputs and user projections of health costs has not included a means for weighting the model or recommendation according to user preferences (e.g., U.S. Pat. No. 7,426,474) or potential variations in the user's healthcare needs (e.g., PCT/US2012058855).

Other existing solutions require an individual user to input detailed personal information, including without limitation income and financial information, prior to obtaining even a cost estimate (e.g., U.S. Pat. Nos. 6,735,569; 7,899,689; 8,306,832; 7,490,050; 7,343,309; US 2010/0223078; US 2012/0022898). Existing methods also ask the user to guess or suggest particular risks for the system to evaluate (e.g., U.S. Pat. No. 8,306,832) or to input or guess the cost of particular healthcare services or goods such as prescriptions (e.g., U.S. Pat. No. 8,442,847). Such inputs not only discourage users from completing a quote process, they expose the user and the entity collecting the user data to cybercrime and other forms of snooping, and may require sharing some forms of personal health information with an employer.

Previously cited cost modeling functionality has been directed to benefit either employers purchasing group plans on behalf of employees (e.g., U.S. Pat. Nos. 6,735,569; 7,899,689), providers (e.g., U.S. Pat. Nos. 5,924,073; 5,953,704; US 2006/0248008) or insurance carriers (e.g., U.S. Pat. No. 7,444,291). These solutions are designed for improvement of those groups' own entity-level operations. Alternately, cost-modeling has been directed at what a particular healthcare provider will charge a particular patient or for a particular procedure, without reference to the applicability of a plurality of plans to that provider or that health scenario.

Previous modeling systems have alternately required persistent, specific, and therefore, costly and time-consuming methods for obtaining information from healthcare providers or insurance carriers (e.g., U.S. Pat. Nos. 6,735,569; 7,444,291; 7,343,309; US 2012/0022898). These methods suffer because they depend upon participation by a large group of supply-side entities to produce accurate models.

Previous solutions have not included components necessary to generate healthcare-related evaluations to a user in customized form (e.g., U.S. Pat. Nos. 8,315,891; 5,956,691; US 2004/0024619). Such solutions have also been limited to the evaluation of a single specific condition and the associated costs (e.g., U.S. Pat. No. 8,095,384 (B2)).

To this end, existing solutions are inadequate because their outputs are not reliable. Consumers might still find, upon actually applying for coverage, that the price of such coverage differed.

The difficult and time-consuming nature of evaluating and purchasing health insurance options has been widely publicized, as has the dissatisfaction in the marketplace with (1) the imperfect and/or confusing information conveyed by current platforms that seek to summarize and/or sell health insurance plans and (2) the time commitment necessary for an ordinary consumer to evaluate and/or purchase health insurance. Existing systems, including government systems, have addressed difficulties in the user interface by providing phone or chat-based support personnel, who may or may not be equipped with the relevant information to guide consumers through the evaluation process. Accordingly, there is a need in the market for a solution that solves or at least ameliorates some of the issues with existing health care insurance comparison solutions.

### SUMMARY OF THE EMBODIMENTS

In view of the foregoing, an object according to one aspect of the present patent document is to provide methods and apparatuses for consumer evaluation of insurance options. Preferably the methods and apparatuses address, or at least ameliorate one or more of the problems described above. To this end, computerized and networked insurance evaluation and purchase systems, methods and apparatuses are provided. In one embodiment, a method for transforming user data inputs into a health insurance plan recommendation is provided. The method comprises: receiving user data inputs from a graphical user interface including location data, gender data, age data and smoking habits data; determining a subset of available health insurance plans from a set of plans in a database based on the location data; querying a second database for historical data records that match a subset of the user data inputs; receiving health event data about a plurality of health events for each historical data record returned by the query; calculating care cost for each health insurance plan in the subset of available health insurance plans by calculating costs associated with the health events under each health insurance plan in the subset of available health insurance plans; calculating a total cost of ownership for each health insurance plan in the subset of available health insurance plans by adding monthly premiums for each health insurance plan in the subset of available health insurance plans to the care costs for that plan; and, transmitting a health insurance plan recommendation based on the total cost of ownership to the graphical user interface.

In preferred embodiments, the health insurance recommendation is based exclusively on the total cost of ownership. In yet other embodiments the total cost of ownership is only one factor in selecting the recommendation.

In some embodiments of the method, a plurality of categories including total cost of ownership may receive a weighted consideration. In such embodiments, the method may further comprise: creating a plurality of weighted multipliers based on the user data inputs; producing a plurality of category scores for categories including benefit levels, cost sharing, provider network volume, care and drug availability for each health insurance plan in the subset of available health insurance plans; multiplying each category score by a weight multiplier from the plurality of weighted multipliers to produce weighted category scores; multiplying the total cost of ownership by a weighted multiplier to produce a weighted total cost of ownership; summing the weighted category scores and weighted total cost of ownership for each health insurance plan in the subset of available health insurance plans to produce a total weighted score; and, transmitting the health insurance plan recommendation of the health insurance plan with the highest total weighted score.

In some embodiments, the method further comprises, causing to be displayed on the graphical user interface the health insurance plan recommendation, the cost of care for that plan, and the premiums for that plan.

Although the embodiments preferably require as little data input from a consumer as possible, in some embodiments, the user data inputs further includes supplemental user data input selected from the group consisting of medications currently taken, a desired doctor, and current medical conditions. This supplemental user data input may be used to calculate at least one weighted multiplier. In still yet other embodiments, the user data input is data about a plurality of people in a family.

In still yet other embodiments, the method may further comprise: receiving data about a health scenario; recalculating the care cost including the health scenario for each health insurance plan in the subset of available health insurance plans; recalculating the total cost of ownership for each health insurance plan in the subset of available health insurance plans; and, transmitting a new health insurance plan recommendation based on the recalculated total cost of ownership to the graphical user interface.

In some embodiments, the consumer/user may be able to purchase an insurance plan and in particular, the recommended plans directly via the software. In such embodiments, the user may be enrolled in a health insurance plans directly through the graphical user interface.

As described more fully below, systems, apparatuses and methods for consumer evaluation of insurance options is provided. Further aspects, objects, desirable features, and advantages of the systems, apparatuses and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 illustrates one embodiment of a system 10 for implementing the methods of providing a health insurance recommendation disclosed herein

FIG. 2 illustrates one embodiment of a method to provide a consumer with a health insurance plan recommendation according to the present patent document.

FIG. 3 illustrates one embodiment of an initial screen of a graphical user interface for providing a health insurance recommendation.

FIG. 4 illustrates one embodiment of a screen to allow a user to input information about their personal choice of doctors.

FIG. 5 illustrates one embodiment of a screen to allow a user to input information about drugs they may need.

FIG. 6 illustrates one embodiment of an initial screen of a graphical user interface for providing a health insurance recommendation.

FIG. 7 illustrates one embodiment of a screen to allow a user to input information about drugs and/or doctors they may need or want.

FIG. 8 illustrates the screen of FIG. 7 with a drop down search/selection interface for selecting a doctor deployed.

FIG. 8 illustrates the screen of FIG. 7 with a drop down search/selection interface for selecting a doctor deployed.

FIG. 9 illustrates an initial screen of one embodiment of a graphical user interface that request the user to input a plurality of basic data inputs.

FIG. 10 illustrates one embodiment of a graphical user interface where a consumer can enter information about an illness.

FIG. 11 illustrates one embodiment of a graphical user interface that allows a consumer to adjust potential spending via a slider interface.

FIG. 12 illustrates an embodiment of a graphical user interface that allows a consumer to evaluate the performance of a health insurance plan under various different scenarios.

FIG. 13 illustrates an embodiment of a graphical user interface that displays a health insurance recommendation along with accompanying data.

### DETAILED DESCRIPTION OF THE EMBODIMENTS

The following detailed description includes representative examples utilizing numerous features and teachings, both separately and in combination, and describes numerous embodiments in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

Some portions of the detailed descriptions that follow are presented in terms of algorithms and sequences of operations which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

The embodiments disclosed also relate to an apparatus for performing the operations herein. This apparatus may be specially constructed for the required purposes, or it may comprise a general purpose processor selectively activated or reconfigured by a computer program stored in the electronic device. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, Flash memory, magnetic or optical cards, or any type of media suitable for storing electronic instructions, and each coupled to a computer system bus.

The algorithms presented herein are not inherently related to any particular electronic device or other apparatus. Various general purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the embodiments as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but not intended to limit the dimensions and the shapes shown in the examples.

The present patent document relates to computerized and networked insurance evaluation and purchase, with specific emphasis on permitting consumers to enter limited personal information and receive access to an interactive platform for evaluating the most relevant information about complicated health insurance plan options. The embodiments disclosed herein help solve or at least ameliorate the growing problem of consumer confusion in connection with the purchase and maintenance of health insurance.

Preferred embodiments include a computerized method and tool to enable consumers to evaluate insurance plan options with respect to fixed needs and/or variable contingencies. Certain points of data about a healthcare consumer may be processed through computerized methods to produce a multivariable data set which can be displayed simply, but in a plurality of formats, to a user. The embodiments allow consumers to access metrics applicable to their personal healthcare needs and demands in order to assess whether various insurance options will provide insurance coverage or reimbursement in relevant scenarios and for relevant individual and family costs.

In preferred embodiments, consumers provide a bare minimum of information about themselves within a computer and/or processor-based interface. The reduced information entry minimizes the previously-cumbersome measure of time necessary to conduct an evaluation of health options. After such entry by users, the preferred embodiments employ a computer- or processor-based medium to deliver a visualized means of exploring vast amounts of competitive data about health plans and the medications, providers, and events covered by such health plans as related to the individual users' expressed needs. Some embodiments may further project annual healthcare costs under a plurality of insurance plans based on user inputs, including additional user specifications of a particular incident or scenario. The healthcare costs permit an individual to visualize and understand the various characteristics of otherwise-opaque health insurance options in light of the total cost to the user over a specified time period. The healthcare costs may include costs for specific care events, health scenarios or other predicted or existing events or conditions. The embodiments disclosed herein may also facilitate the purchase of recommended coverage through its simple computerized components.

Because health insurance premium pricing is now constrained by federal law (or permitted state laws) to three age “bands,” or disparately-treated groupings (namely, children, adults, and older adults, with children and older adults in a single “band” for pricing purposes and adults segmented by year in 43 smaller “bands”), the embodiments disclosed herein permit consumers who provide their age (as well as, in some embodiments, those of their dependents) to obtain a definitive price for insurance coverage and/or plans according to that age.

The Affordable Care Act and its implementing regulations further limit insurance pricing on the basis of geography: states geographical rating areas must be based upon geographic divisions of counties, three-digit zip codes, or “metropolitan statistical areas;” thus, the embodiments disclosed herein permit consumers who provide their geographic location to obtain a definitive price for insurance coverages and/or plans according to that location.

In addition, tobacco use is permitted as a pricing factor, but the price variation tobacco use may impose upon premium pricing is capped at a ratio of 1.5:1; thus the embodiments disclosed herein may permit consumers who provide their tobacco use status to obtain a definitive price for insurance coverages and/or plans according to that status.

The Affordable Care Act further segments legal health plans into a limited number of coverage “levels” (e.g., Bronze, Silver, Gold, Platinum) selectable by a user. Because of these categorical and ratio limitations, which are subject only to limited modifications by the states, the embodiments disclosed herein can introduce the capability to make more accurate predictions with more limited data fields than ever before.

A user may also elect to (but need not) enter information about his or her personal care preferences and other attitudinal preferences, and the preferred embodiments disclosed herein may weigh the ultimate plan recommendation or recommendations on the basis of such unique user inputs and expressed preferences.

To these ends, in some embodiments, a health insurance plan may be recommended based solely on only a few data inputs from a consumer. For example, in one embodiment, a health insurance recommendation including the cost of care and premiums may be provided with only the consumer's location and age as data inputs. In other embodiments, a health insurance recommendation including the cost of care and premiums may be provided with only the consumer's location, age and gender as data inputs. In still yet other embodiments, a health insurance recommendation including the cost of care and premiums may be provided with only the consumer's location, age, gender and smoking habits as data inputs. In yet other embodiments, other data inputs from the user may be used.

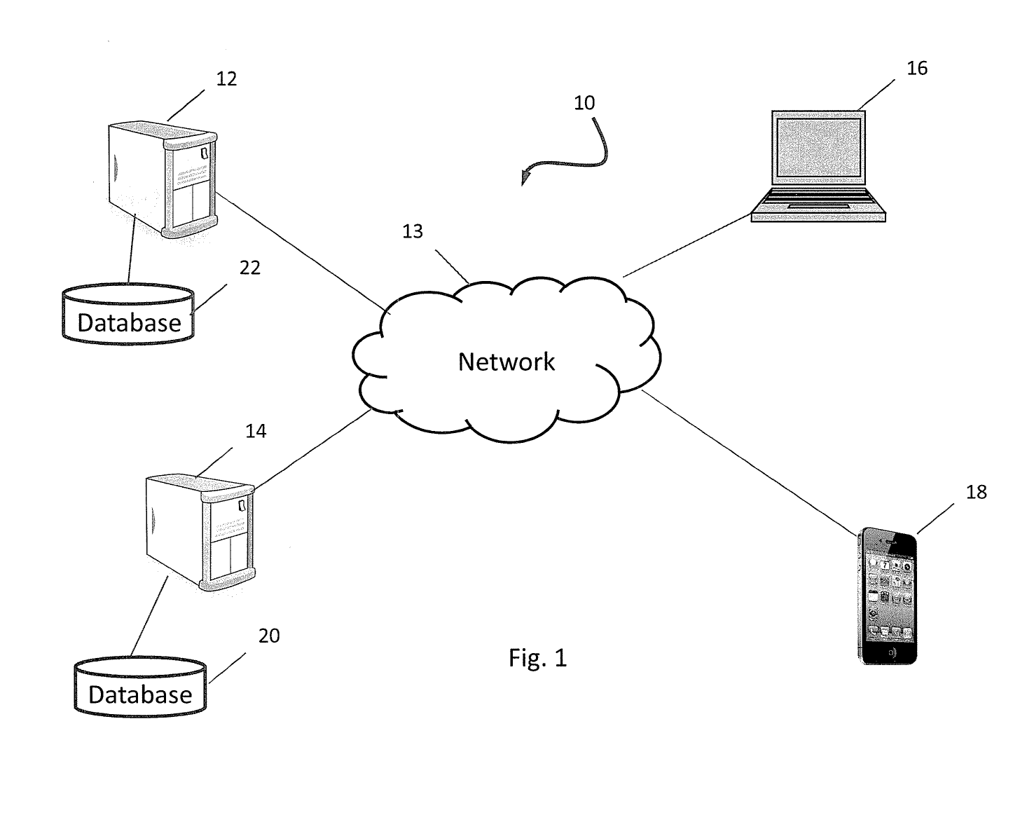

FIG. 1 illustrates one embodiment of a system 10 for implementing the methods of providing a health insurance recommendation disclosed herein. As may be seen in FIG. 1, the systems may include one or more servers 12, 14 and may serve a graphical user interface to one or more consumer devices 16, 18. In preferred embodiments of the systems 10 disclosed herein, a processor and/or server 12, 14, operate in conjunction with a database 20, 22. A website is hosted on a digital platform and populated with detailed information about health plans, including for example a plan's name, the insurance carrier, premium pricing information, provider networks, deductibles, limitations, out-of-pocket maximums and coverage exceptions, co-pays, prescription drug coverages, publically available information regarding such provider and prescription pricing and ratings, among other relevant information. In some embodiments, the database 20, 22 may be appended with a system or software to calculate costs of various health scenarios on the basis of the costs of such scenarios for individuals with a similar demographic profile to the user.

In a preferred embodiment, a statistical model is created using a database 20, 22 that reflects the core attributes of a plurality of health plans, and then compares them to the users' inputs. A ranking or recommendation is generated with reference to the total projected spending of a user for each plan in the database; this ranking or recommendation is the result of weighting the health plan information in the database 20, 22 according to the factors the user defined as relevant or important to him or her.

Embodiments of the present patent document allow the consumer to quickly and easily answer a simple and fundamental question: “which available health insurance plan will help me with the care I want or need for the lowest total cost?” The embodiments of the present patent document may also give the consumer the opportunity to compare the quality and convenience of the services included within each health plan he or she evaluates.

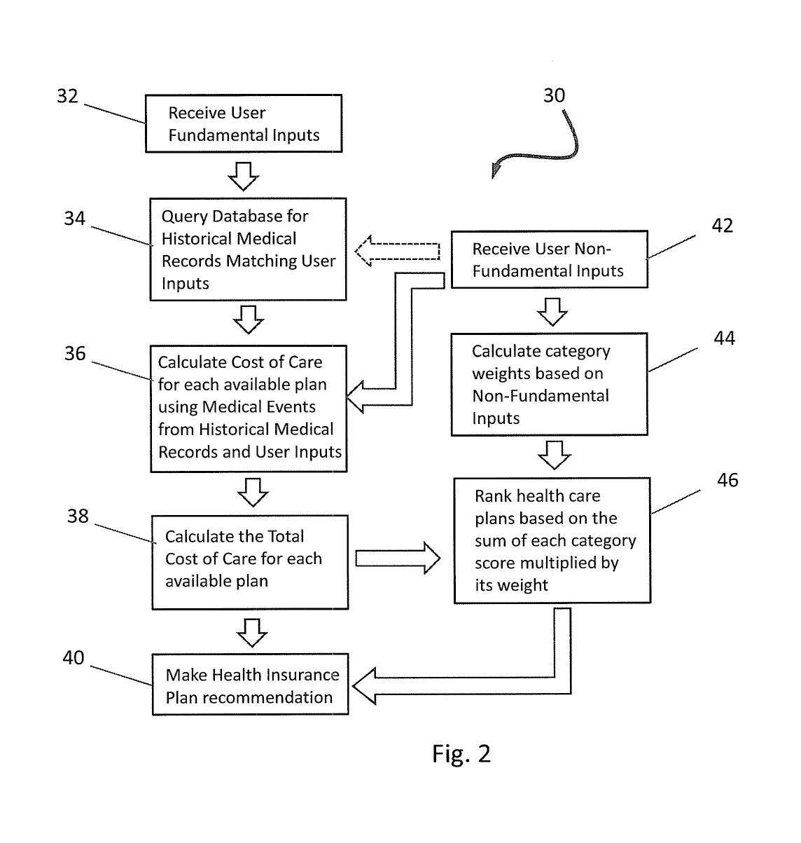

FIG. 2 illustrates one embodiment of a method 30 to provide a consumer with a health insurance plan recommendation 40 according to the present patent document. In preferred embodiments, the cost of care is estimated 36 by querying one or more databases 34 to get statistical information about health care events of other people with similar demographic information to the consumer. This statistical information may also be referred to herein as historical medical records.

As may be seen in FIG. 2, two types of inputs may be received from the user: fundamental inputs 32 and non-fundamental inputs 42. Fundamental inputs are those minimum inputs required to query for statistical information about people similarly situated to the consumer. Fundamental inputs include age, gender, location and smoking habits. However, non-fundamental inputs may also be received from a consumer 42. These inputs may be used to calculate category weights 44, which are multiplied by category scores to help rank the available plans according to the consumers needs as explained in more detail below. Non-fundamental inputs include but are not limited to preferred medical professionals, current prescriptions and existing conditions. In some embodiments, non-fundamental inputs may also be used to query for additional historical medical record information 34.

Once the information is received, simulations of the health care events of those similarly situated people may be run through each health care plan to produce a cost of care for each plan 36. To this end, embodiments described herein may make use of representative population data sets and historic medical events to identify highly-unique subpopulations that can be used for predictive purposes to estimate health care costs for a user who has entered in basic demographic and health characteristics 32. Accordingly, a statistically predictive cost of care may be calculated 36 with very little data from a consumer. In many cases, the predictive estimate may be even more accurate than in other system that require a consumer to enter additional information because the statistical prediction takes into account the probabilities of unforeseen events by using historical data.

The consumer inputs may include age, location and gender, and may additionally include chronic illness or disease specification, consumption of prescription medication, relative health statuses, and consumption of tobacco. Based on these inputs, a subpopulation is selected from the representative population data set that exhibits similar health care consumption and cost characteristics as the specifying user. The historic medical records of the individuals in the representative population are then used to calculate a set of events that are likely to occur in the future, typically over 1-3 year period, as well as a probability of occurrence. Each event in the set has an associated cost, and is additionally mapped to a health plan benefit service type. Based on this set of events a total expected care cost can be calculated 38 for a multiplicity of health plans or stand alone. The expected cost and probability of occurrence can also be weighted 44, 46 based on additional user inputs or specifications, including risk or utilization indicators. Further, the mix of benefit service types may be used to weight priority to health plans which provide better coverage for different benefit service types 44, 46.

In some embodiments, the historical medical records may be received from a public server that provides access to such records. In other embodiments, the historical medical records may be obtained from a private server. In yet other embodiments, the historical medical records may be provided by both public and private servers.

In determining which historical medical records are relevant, embodiments may use some or all of the information input by the user. To this end, as used herein, it should be understood that in some embodiments a “subset” may include the set of all elements of the set from which it describes. In selecting which historical records are relevant, embodiments may look for an exact match to the inputs or may allow a range of values on either side of the input to satisfy as a “match.” For example, if the user is age 35, some embodiments may look for only historical data of other 35 year olds while other embodiments may use data from 34-36 year olds, as just one example. Accordingly, as used herein with respect to selecting historical medical records, the word “match” is not required to be an exact match.

In some embodiments, health care costs may be calculated for every plan in the database based on historical medical records returned that match the query designed for a particular consumer. However in other embodiments, care costs may only be calculated for a subset the available health insurance plans. For example, a consumer's location may be used to retrieve a subset of available plans available in a particular geographic location. In further processing, only the available plans for the consumer's geographic location need to be included for calculations related to care costs 36 and total cost of ownership 38.

Embodiments disclosed herein may further be suited to the needs of individuals who do not have the opportunity (or do not find it cost-effective) to purchase health insurance through an employer. Moreover, some embodiments may be suitable for evaluation other than by an individual purchasing on his or her own behalf, including without limitation by employers purchasing on behalf of individuals.

The embodiments disclosed herein are different from previous solutions in numerous ways. In particular, embodiments of the present patent document are different from any solutions prior to Jan. 1, 2014, because the Affordable Care Act's requirements did not constrain the pricing of health insurance premiums; thus, previous solutions could not have disclosed a system for evaluation of health insurance plans that referenced the types of fixed, pre-determined premium pricing metrics available in the present embodiments.

Preferred embodiments of the present patent document are not dependent upon historical data about a patient or his or her claims; it is neither subject to the errors inherent in reconstructing and analyzing a patient history nor dependent upon users' significant time commitment or users' understanding of healthcare services. The preferred embodiments disclosed herein avoid privacy and data security flaws by requiring personally-identifiable information such as name and exact address only when the user chooses to engage in an insurance purchase transaction.

Preferred embodiments of the present patent document may use a process through which recommendations are simultaneously displayed in the order of their projected cost-benefit balance to the specific consumer, which permits the “best” recommendation to vary according to the user inputs and the selected prospective scenarios with a single-screen, easy to use interface. Preferred embodiments of the present patent document may display a narrative recommendation focusing on the costs considered for the “recommended” insurance plan as-applied to a user's choice of doctors, drugs, or conditions, while presenting the user the ready option to explore the operation of other health plans with limited inputs.

In preferred embodiments, computerized methods are used. The computerized methods eliminate the need to enter detailed personal information to simply price insurance plans. Instead, the computerized methods allow a user who is neither registered nor logged in (though they may choose to be) to enter enough information to enjoy the benefits of an insurance comparison with a few clicks and/or quick searches.

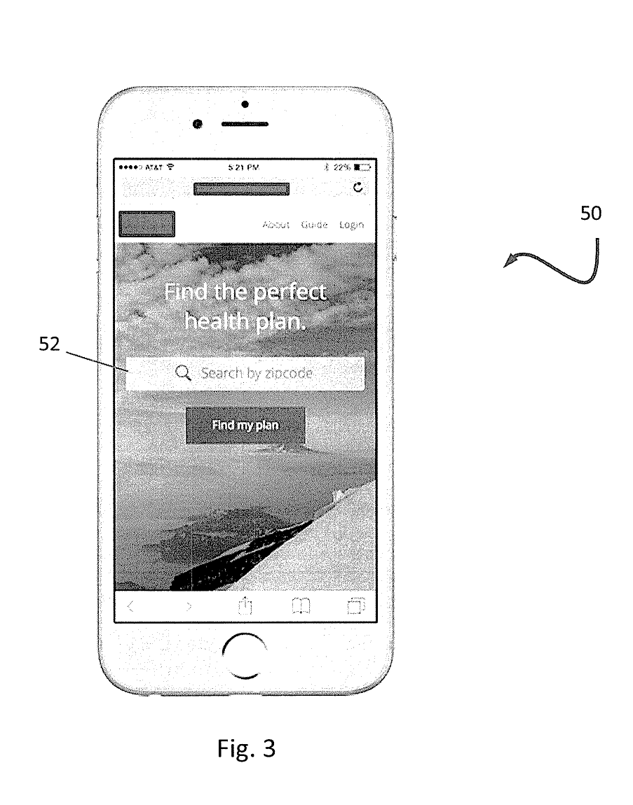

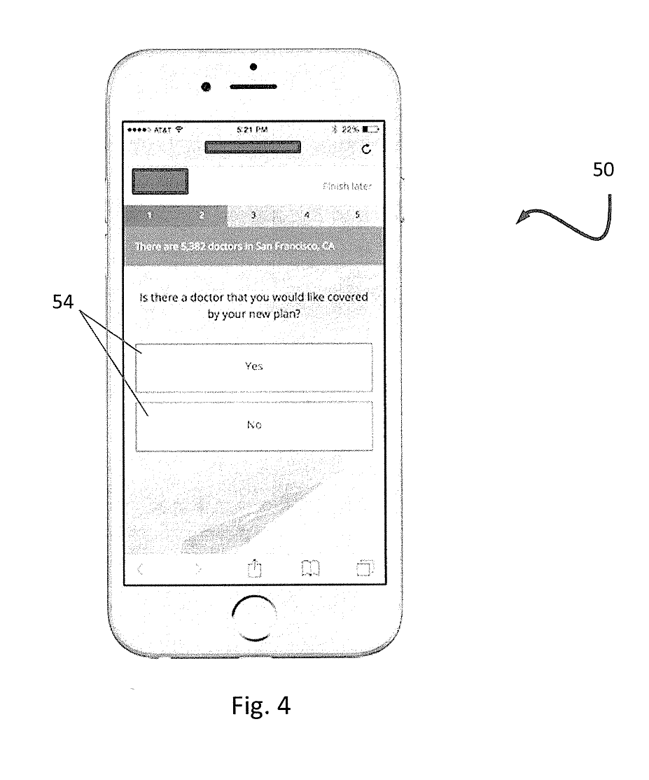

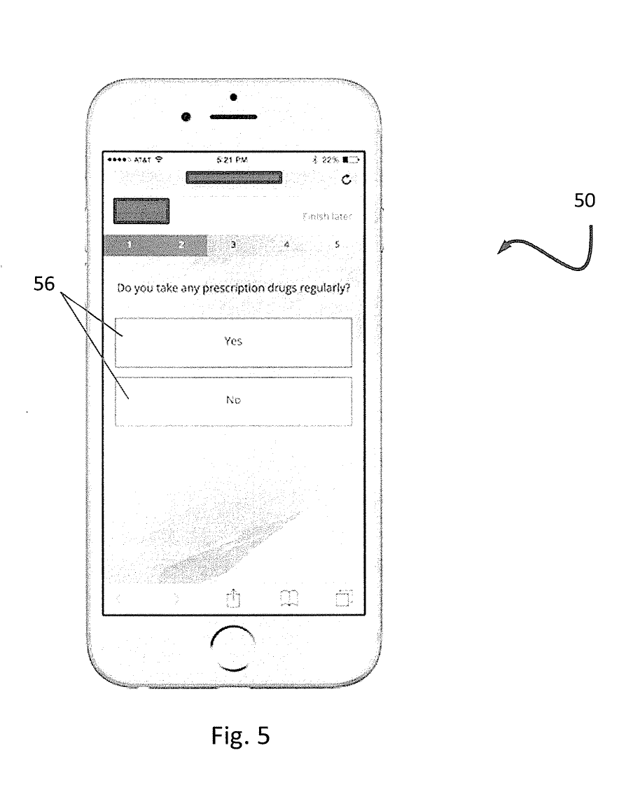

FIG. 3 illustrates one embodiment of an initial screen of a graphical user interface for providing a health insurance recommendation. The embodiment shown in FIG. 3 is particularly designed for a mobile device and different embodiments may be used for other display sizes or capabilities. As may be seen in FIGS. 3-5, in some embodiments a users input may be limited to a single data item per screen. A zip code 52 is entered on the screen in FIG. 3. A doctor selection 54 is entered on the screen in FIG. 4, and a prescription drug query 56 is entered on the screen in FIG. 5.

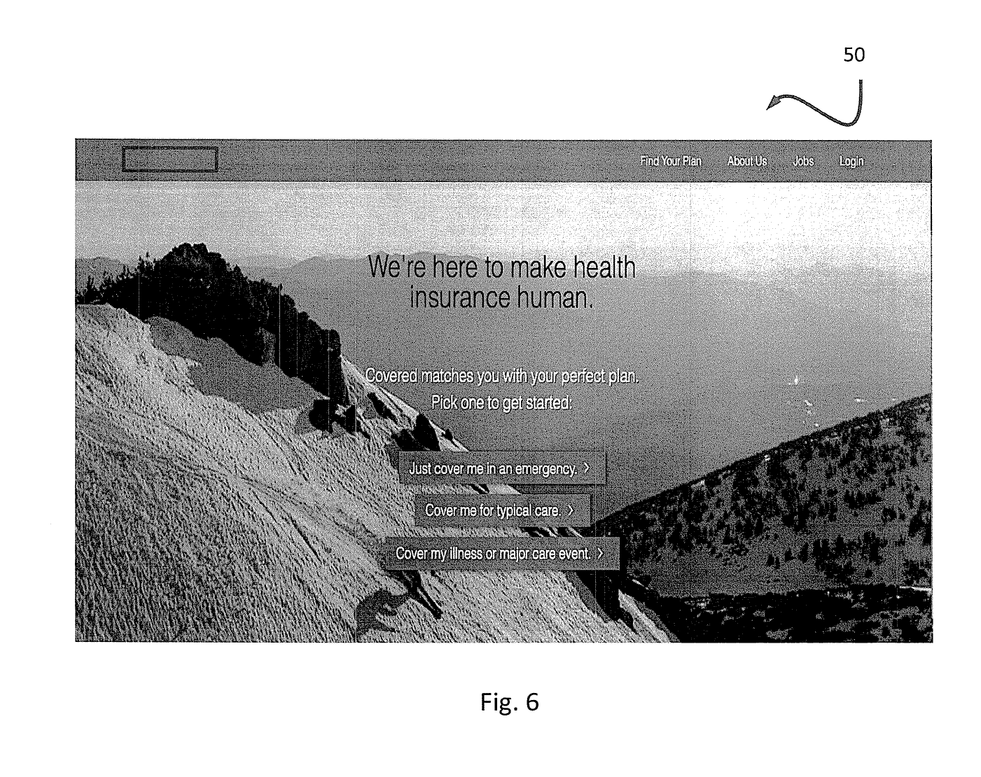

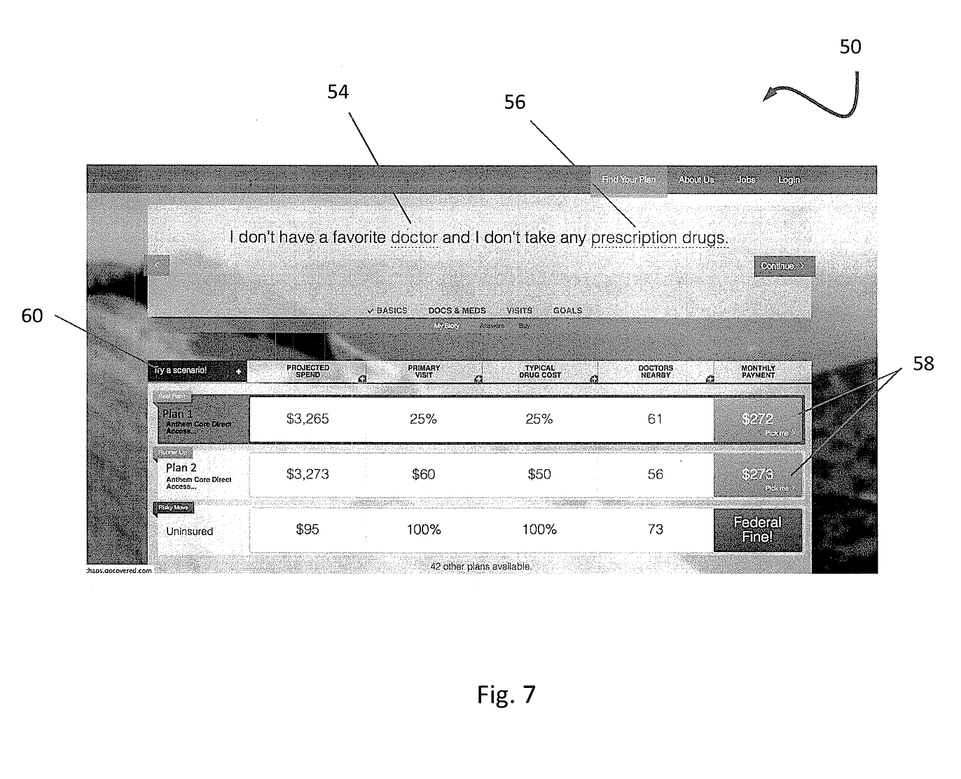

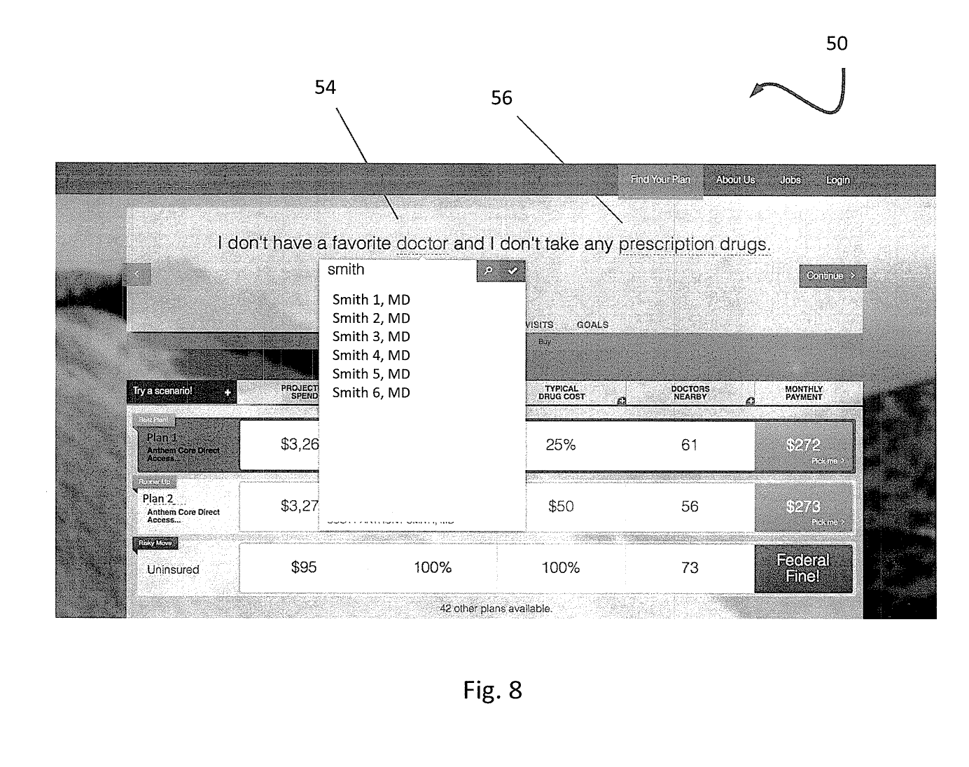

FIGS. 6-8 illustrate a different embodiment of a graphical user interface that may be used to initiate a health insurance recommendation and receive inputs from a user. The embodiment illustrated in FIGS. 6-8 are designed for display on the screen of a laptop or desktop computer instead of a mobile device. As may be seen in FIGS. 7 and 8, the selection of a doctor 54 and particular prescription drug 56 are both displayed on the same screen through the use of a clickable link. One skilled in the art would understand that although a particular graphical user interface may be designed for display on a particular type of device, it may be used on any device.

The simplification of the data entry process on the part of consumer does not limit the detail available for his or her evaluation of health plans. Instead, preferred embodiments of the present patent document collate the user data into a graphical interface delivered through a computer network. The interface of a preferred embodiment allows the user to access significant information about health plans that are available, organized according to their cost and benefits to such user, and, in some embodiments, also allows the user to complete the purchase of a desired plan.

As may be seen in embodiments like FIG. 7 and FIG. 8, the premium price 58 may be displayed. Unlike previous solutions, the premium price 58 displayed is not an estimate or quote subject to change upon a user's final, separate application for insurance coverage; rather, the price displayed is precisely the premium the user will have to pay if the user has entered accurate information about himself, herself and/or his or her family. Further, the user has the capacity to evaluate said health plans in the context of exemplary scenarios 60 that might change the user's total healthcare spending over the course of an applicable period. A “scenario” 60 as used herein means any particular health care event or series of events such as pregnancy, concussion, sprained ankle, broken leg, cancer heart attack or any other type of particularized health event. As may be seen, scenarios 60 may be prepopulated and presented without copious entries from the user—eliminating the need to calculate the cost of scenarios 60 in light of detailed information about particular consumers' medical histories or according to scenarios entered by the user in a time consuming manner. In addition, each option for health insurance plans may be presented with concise visual summaries of (1) whether particular doctors or prescriptions are covered by the applicable plan, and/or (2) pre-existing and/or customized assessments of the quality of health providers within the network of a particular health plan.

Herein, the terms “healthcare consumer,” “user,” and/or “consumer” are used to denote a person who is entitled to benefits, reimbursement, and/or service under a healthcare benefit plan. As used herein, a healthcare consumer may be a primary and/or responsible party under a healthcare benefit plan and/or any dependents of the primary and/or responsible party and/or any other parties entitled to benefits and/or service under a healthcare benefit plan.

Returning to FIG. 1, embodiments are implemented in a computerized system 10 including a conventional computing system 12, 14 running a conventional operating system such as Microsoft Windows, Apple OS X, Unix or Linux-based operating systems, or other similar operating systems, now-extant or later-developed, which manages operations on a computerized platform. Embodiments may be implemented on alternative systems, such as mobile-device operating systems (including without limitation Apple iOS versions, Android mobile operating systems, or other similar mobile operating systems), and including any computerized or digital system capable of running a software application, whether known at the time of filing or as developed later. Such system may additionally include those capable of executing application software code over a network 13 connection of any kind, now known or later developed, wherein the computing resources utilized are located remotely. In any case, the application or program embodying the invention may operate from a fixed platform or upon any computer processor capable of executing software applications, wherever located and however organized, and regardless of the underlying hardware used to execute software functions.

Output generated by one or more embodiments can be displayed on a display screen of any size or nature, delivered over a computerized network 13 to a device, stored on any database, computer server or other storage mechanism, printed, or used in any other way. In addition, in some embodiments, processes and/or systems described herein use input originating from any type of user interface, such as a keyboard, mouse, touchpad, tablet, touchscreen, or any other device capable of providing user input to a computing system or for translating user actions into computing system operations, whether known at the time of filing or as developed later.

Preferred embodiments include a user-facing, client-side interface comprising at least (1) a means for allowing a user to read digital outputs and (2) a means for a user to interact with a computerized system by inputting data and/or selecting from among a plurality of data points. In various different embodiments, the inputs may be either by manually entering data or selecting from among pre-populated options in order to convey certain data about a consumer of healthcare services (the “Interface”), which may be practiced in multiple formats. The Interface may be capable of collecting, through any method of data entry, one or more data points about a user relevant to the pricing of health plans, which data points may include: geography, marital status, number of children, tobacco use or lack thereof, age, and gender, just to name a few. In some embodiments, the data points may further include a user's existing health conditions. In other embodiments, the data points may further include a user's personal care preferences and the “level” of insurance plan desired by a user. In yet other embodiments, the data points may further include certain medical procedures a user anticipates having in a specified time period, certain prescription and non-prescription medications a user might wish to use in the specified time period, and/or doctors or other healthcare providers a user may wish to visit in the specified time period. In certain embodiments, some or all of these inputs may be projected or estimated by software functions on behalf of a user on the basis of other user inputs. However, in some embodiments, users may be permitted to enter only partial data or omit data relevant to the pricing of health plans.

In one embodiment, a user's initial access to the interface through any computerized medium generates a unique piece of software code used as a reference (e.g., a “software cookie”). This unique piece of software code enables the Plan Database (an embodiment of which is further described below) to reload user data previously input into the interface without requiring users to input personal health information or information associated with any natural person. This preserves user privacy. In addition, the use of the software cookie in conjunction with the present invention streamlines the health plan evaluation method disclosed herein by further shortening the time necessary to evaluate a health plan. This method is particularly effective when users exit and revisit the interface through a web browser or similar technology.

In one embodiment, as described in further detail below, the Interface is a software application that includes: (1) a series of displays capable of receiving data inputs, with a limited number of data points enabled for input on each screen, and with each screen providing a user the opportunity to continue through the data entry process with a single instruction to the user-facing platform (such as a click of the mouse on a particular screen location) and (2) a back-end computerized data processing system, as described below, which analyzes a data set regarding health plans according to a user's data inputs.

In preferred embodiments, the various embodiments of the graphical user interface operate with reference to one or more databases 20, 22 as further described herein. In one embodiment, the interface facilitates a process for permitting consumers to evaluate a plurality of health plans according to projections of those plans' aggregate cost to an individual over a specified time period, as described in further detail below, and both the interface and the supporting digitized data are stored, in whole or in part, on any form of computerized memory (whether accessed via a direct connection or through a networked connection), including without limitation a hard drive, server, cache, database, or other storage medium which is accessible and executable by another computerized system.

In one embodiment, output may be generated through the use of the database 20, 22, or any similar mass storage device capable of housing data processed, aggregated, and analyzed per the previous description of an embodiment, and said database 20, 22 may be composed of hardware, software or a combination of hardware and software. A computer processor or its equivalent performs the analytical functions of the present invention, maintains the data housed in the database 20, 22, and/or performs the calculation necessary to make the health plan recommendation or display the health plan evaluation tool described herein.

In one embodiment, the computing system and the database 20, 22 are used in conjunction with a server system 12, 14 and a network 13. The network 13 may be any network or network system, including without limitation a (1) limited-access network system such as a Wide Area Network (WAN) or Local Area Network (LAN) and/or (2) a public network or network system, such as the Internet or a mobile data transmission platform and/or (3) any other network capable of allowing communication between two or more computing systems (whether through analog modems, digital modems, a network interface card, a broadband connection, or any other means for communicably coupling computing system or their equivalents now known or later developed), whether known at the time of filing or as later developed.

As used herein, the term “provider” may be used to refer to any provider of healthcare services, including a physician, a hospital, an urgent care facility, an outpatient facility, a nurse, a physical therapist, a counselor, or other persons or entities capable of providing medical services to a consumer. As used herein, the term “provider network” may be used to refer to the plurality of providers characterized as “in-network” by a particular health insurance carrier and/or plan, such that the cost to the consumer of visiting those “in-network” providers when covered by a particular plan is categorically lower than the cost of visiting providers who are not “in-network.”

In one embodiment, the database 20 is comprised of digitized information regarding some or all health plans available to a user (“Plan Database”). In one embodiment, the Plan Database is composed of information which includes, by way of example and not of limitation, (1) insurance carriers, (2) carrier's health plan names and pricing, (3) health plan provider networks, including information about the location in which providers operate, groups of providers with certain characteristics in common, (4) provider pricing (whether actual pricing, projected pricing or anticipated pricing), (5) quality and efficacy measures of (a) health plans, (b) healthcare providers and/or (c) hospitals, (6) publicly available lists of medications (prescription or otherwise) and related dosages, (7) the approach of various plans and providers to certain medical conditions, which may include grouping applied to such conditions, (8) information relating to diagnosis and treatment of medical conditions and medical procedures such as any cost groupings associated with a particular carrier, provider, or health plan or other subset of health services, and/or (9) a software module capable of processing and/or analyzing any of the above. In some embodiments, such data may be processed, aggregated, or correlated according to geographic location, or may be modified to reflect certain user characteristics, or otherwise organized in order to match the user inputs through the Interface.

In one embodiment, the Interface and the Plan Database are connected by, and their interactions are managed by, certain software code that communicates information in electronic format between the interface and the Plan Database. This software code may be referred to herein as the “Manager.” The Manager may be an additional software module, which may run on the same or on a different processor or computer system than the other software modules comprising the Invention (including without limitation computer database systems, web server systems, and client computer systems, which may or may not be connected by a network). In some embodiments, the Manager is comprised of software code operating over a computerized network that sends signals between the interface and the Plan Database. In some embodiments, the Manager will control the operation of servers and/or a Plan Database. In other embodiments, the servers and/or Plan Database may be controlled by different software modules (including without limitation the Interface itself). In some embodiments, the Manager will direct the Plan Database or other similar computer processor to analyze and process information contained in such Plan Database or other processor according to user inputs from the Interface. In yet other embodiments, the Manager controls the display presented to a user by controlling, organizing and/or processing the data sent to the Interface for display.

In some embodiments, the user inputs are processed as described above. Specifically, when a user opens the Interface, for example by typing in a specific uniform resource locator through a web browser. Then, the Manager (1) checks the machine the user has employed to access the Interface for a session cookie or similar software code, which may be referenced by the database to the hard drive or other memory system of the device upon which the user has accessed the Plan Database. The session cookie may be accessed in order to return the user to his or her previous point in the progression of the present invention if the user exits the web browser and/or (2) saves a session cookie or similar software code so that it may be referenced during future visits. In each case, this method, as a precursor to and/or element of the embodiments disclosed herein, shortens the aggregate time any user must spend to input data into the Interface.

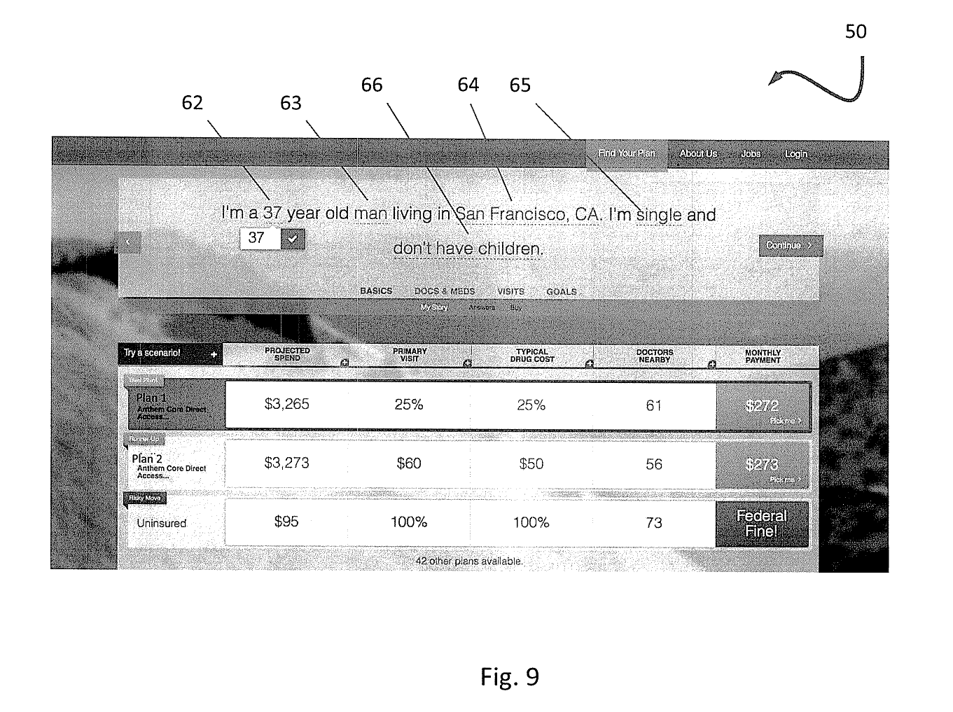

In one embodiment, at a time following the initial placement of the session cookie or similar software code. As may be seen in FIG. 9, the Interface 50 may prompt the user to enter certain basic demographic information, which, in one embodiment, includes a first data entry screen prompting the user to enter an age 62, gender 63, location 64, marital status 65 and number of children 66. In other embodiments, other data inputs may be requested and may be requested using a plurality of screens instead of the single screen used in the embodiment of FIG. 9.

These data points may be entered in any order and may be modified later in the data entry process. In some embodiments, the Interface includes a plurality of data entry screens that may be navigated quickly through a small number of user actions, such as a single click on a forward arrow. In some embodiments, additional information about the user's insurance-related needs may be gathered on a non-mandatory basis, such as the information necessary to calculate the user's healthcare premium subsidy. In one embodiment, each such item of information entered through the Interface is packaged by the Manager and communicated to the Plan Database. The Manager receives calculations for the Plan Database including, without limitation, a list of plans contained in some form within the Plan Database and a ranking of such plans generated through a calculation made using the Plan Database (which calculation may be performed upon receipt of the transmission from the Manager or prior to such transmission) of each health plan's total out-of-pocket cost to the consumer over a specified timeframe. The Plan Database calculation is conveyed to the Interface (by the Manager, Plan Database, or other related software module), which causes a display on the Interface of a health plan recommendation, which might be displayed as a single health plan or a selection among a list of a plurality of health plans. In some embodiments, this display of a plurality of health plans is accompanied by information in digital form which may be displayed as a ranking of the plurality of health plans according to their projected annual cost to a user. In preferred embodiments, the rank returned by the Manager, Database, or other software module drives the order in which plans are displayed to the user such that the lowest-annual-cost plan is at the top of the list of health plans or is the featured recommendation for a health plan for that user.

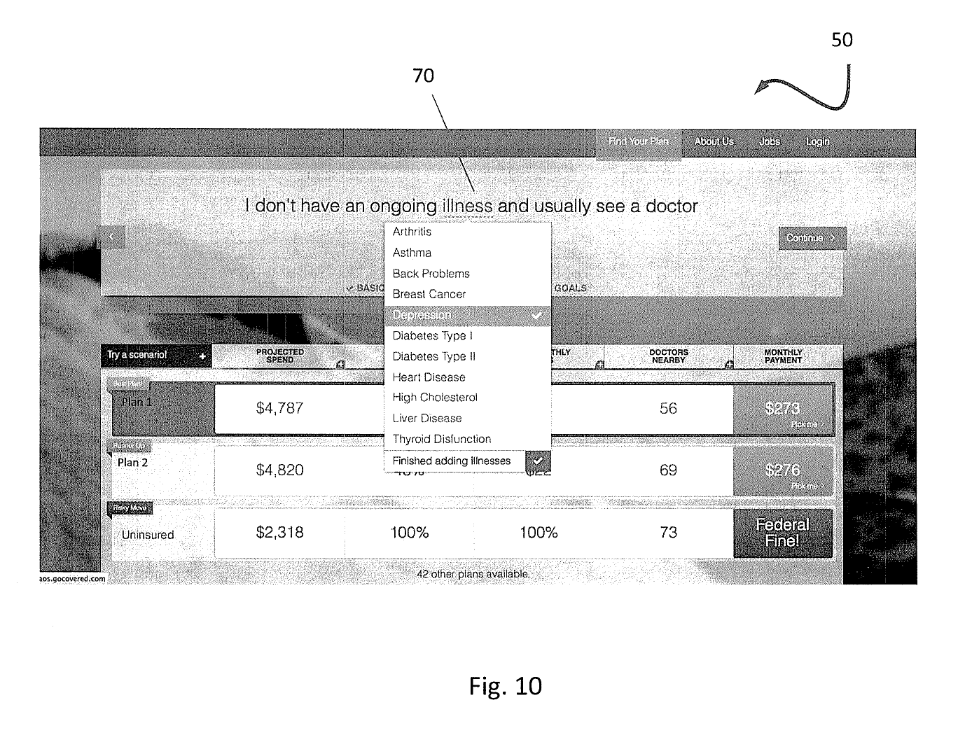

In one embodiment, through the Interface, the user also enters information regarding whether or not he or she is a “smoker” (i.e., smokes tobacco products). As may be seen in FIG. 10, in some embodiments, the user may also enter information regarding an ongoing illness 70 he or she suffers, a particular physician or healthcare provider he or she wishes to visit, and certain prescription medications he or she wishes to use. While in the preferred embodiment, none of this information is required to generate accurate premium prices for a health plan in the Plan Database, more specific information about consumer needs and preferences may be transmitted by the Manager to a computer processor. In some embodiments, the Plan Database; in turn the Manager, may return a revised cost estimate for the user over a specified time period, which takes into account the premium pricing of the plan as well as the extent to which a particular displayed plan covers the providers, doctors, or prescription medications input by the user into the Interface.

In one embodiment, the display of recommended, ranked or unranked health plan(s) may include more detailed information about such health plan(s), and this detailed information may be displayed in a tabular format or as a narrative. In either case, the display may allow for the temporary expansion and contraction of particular items of information about the health plan(s) through the Interface. As may be seen in FIGS. 7-11, in some embodiments, the Interface 50 may allow the user to consider multiple factors influencing the selection of a health plan by a consumer within a single, responsive screen, eliminating the need for copious navigation by the user, whether in narrative or graphic form. For example, in one embodiment, a user may change his or her selection of prescription drugs desired during the applicable time period and the Interface 50 will display rankings modified to reflect the total cost to the consumer over the specified period in light of the change in consumer selection. As another example, a user may change his or her selection of procedures desired during the applicable time period and the Interface will display rankings modified to reflect the total cost to the consumer over the specified period in light of the change in consumer selection. As another example, a user may change his or her selection of provider visits desired during the applicable time period and the Interface will display rankings modified to reflect the total cost to the consumer over the specified period in light of the change in consumer selection.

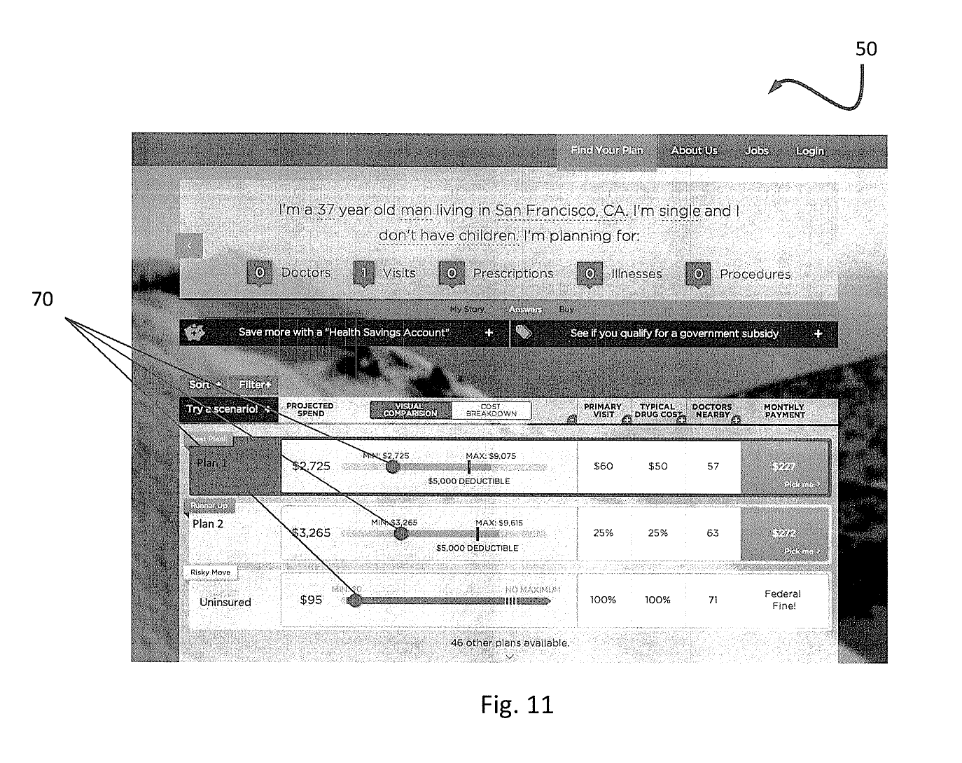

As may be seen in FIG. 11, in some embodiments, the predictions of a user's healthcare spending over the course of a specified timeframe are displayed in a slider format 70 as indicated. In such embodiments, the slider graphic 70 may be presented for each ranked health plan and may be comprised of (1) a range of potential spending bounded by a minimum price equal to the total annual premium payments and a maximum out-of-pocket limit on a particular plan over a specified time period, if applicable; and (2) a projected dollar amount equal to the calculated, prospective total healthcare spending for the specified time period that slides along the aforementioned range and may vary to reflect an updated cost when the user varies his or her selection of particular healthcare needs (i.e., prescriptions) or explores a healthcare scenario (i.e., a broken arm). In some embodiments, these calculations may be further broken down and displayed to the user with reference to premium payments, healthcare provider visit costs, drug costs, and treatment costs for particular procedures and/or scenarios, as well as the decrease in such costs on the basis of health savings account contributions or governments grants/subsidies.

The display of the User Interface may be responsive to and compatible with a plurality of user-facing computerized devices, including without limitation web browsers, operating systems and versions thereof, display screen resolutions, user-selected display parameters (such as window size), and interne connection speeds. Preferred embodiments, respond with comparable speed and efficiency regardless of the computerized system through which a particular user accesses the embodiments disclosed herein.

The embodiments disclosed herein may permit a user to update the information populated using the User Interface at any time during the evaluation process, and such update will result in near-immediate updates to the health plan evaluation data display. In some embodiments, the updates may include an updated recommendation, updated quality evaluation, and updated cost estimate, and/or updated premium prices, among other evaluation metrics.

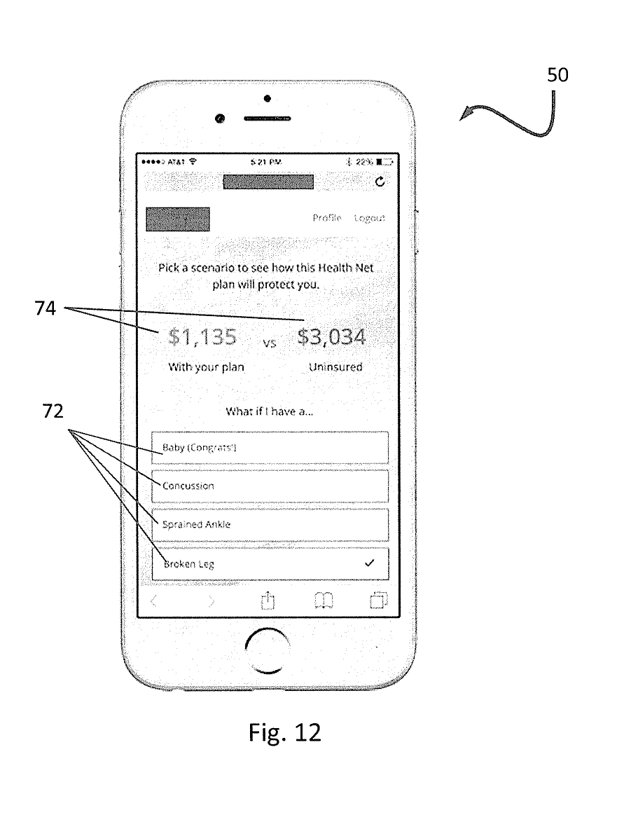

As may be seen in FIG. 12, in some embodiments, the display of ranked or unranked health plans includes a tool through which the user may select from among a set of healthcare incidents or scenarios 72. In such embodiments, the Interface may update with the projected cost 74 to a user over a specified time period under each proposed plan in light of the incidents or scenarios selected by the user.

The user may vary the incident or scenario to be analyzed through the Interface, which may use stored health plan data from the Plan Database including without limitation information about the costs of such a scenario in general or the cost of such a scenario to users with similar location and demographic information to revise the cost estimates displayed to the user according to the chosen scenario. In some embodiments, the embodiments may calculate scenario costs based on one or more of (1) procedure cost and associated costs such as hospital stay, ambulance, etc., (2) the parameters bounding, exposing and/or limiting such costs for a particular health plan (i.e., max out of pocket, co-pays, deductibles) and (3) the treatments necessary for a patient subject to the applicable scenario.

As may be seen in FIGS. 7-11, a single screen display comprising the above plan rankings with premium prices and a total cost of ownership estimate projected over a specified time period may be continuously updated as the Manager or other software module consults the Plan Database or other software module. The Manager may comprise one or more software algorithms to assist in the processing and transmission of data for display to a user through the Interface. The Manager may consult information in the Plan Database which was either (1) generated by data separately purchased or otherwise licensed for inclusion in the Plan Database, (2) generated by data created as a result of a particular user's behavior in connection with the system over time, and/or (3) generated by data created as a result of a plurality of user's behavior and/or selections over time.

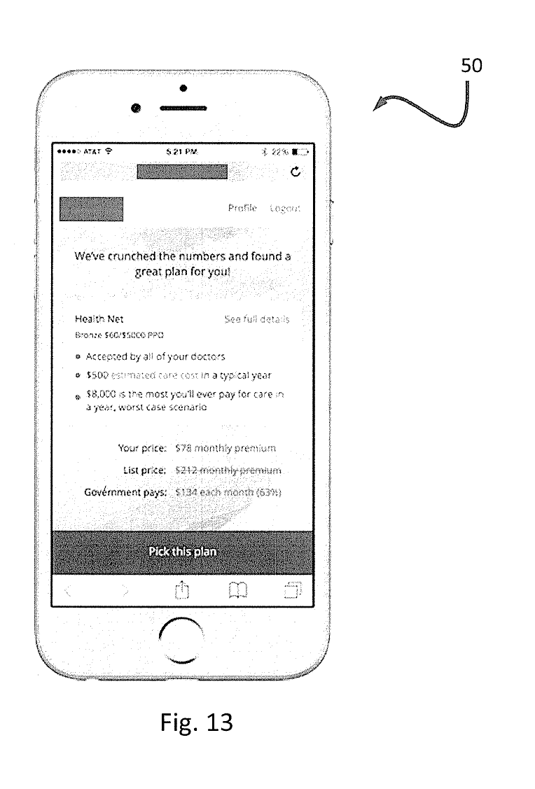

In yet other embodiments, the graphical user interface may be simpler and may not provide a health insurance plan recommendation until a certain amount of inputs and/or screens have been completed by the consumer. FIG. 13 illustrates an embodiment where the health insurance plan recommendation is provided on its own screen and not until the consumer has navigate through a plurality of previous screen requesting specific inputs.

In embodiments described herein, health insurance plans are recommended to a user based on a ranking. In preferred embodiments, the health insurance plans are ranked based on their total cost to the consumer, a.k.a. total cost of ownership (“TCO”). In some embodiments, the total cost of a plan to the consumer may be the exclusive factor in the ranking. In other embodiments, it may only be a factor in the ranking

In preferred embodiments, the TCO is calculated as the predicted out of pocket expenses or cost of care (a.k.a. care costs) for the consumer plus the required premiums (a.k.a. coverage) over the course of the year for any particular plan. Although the premiums are fixed for each plan, the predicted out of pocket expenses may vary based on the inputs provided by the consumer and the algorithms used for calculation. To this end, the rankings based partially or exclusively on TCO may change with each user input. In other embodiments, other algorithms may be used to rank the various health insurance plans and ultimately make a recommendation. In preferred embodiments, these algorithms are based at least in part on the TCO.

In the preferred embodiments described herein, the cost of care is calculated by receiving historical medical data about other similarly situated consumers including their health events, and simulating their costs under the available plans to the consumer. The calculated costs of care for the similarly situated consumers are then aggregated for each plan and a final cost of care is calculated. As just one example, the costs of care for each similarly situated consumer may be averaged for each plan to determine the final cost of care for that plan. In other embodiments, more sophisticated algorithms may be used to aggregate the costs of care for each plan into a final cost of care. For example, costs of care with unusual events may be given less weight than typical costs of care. In other embodiments, other algorithms of varying complexities may be used.

In some embodiments, the plan rankings displayed to the user through the Interface 50 are ranked according not only to the total projected cost to the user of each plan, but also according to weighted algorithms of the various embodiments.

In some embodiments, in order to generate a score and subsequent recommendation, a baseline score may be produced for each plan based on one or more of the following components (categories): 1.) Specific benefit value-levels (i.e. drugs, office visits, hospitalization, outpatient procedures, emergency room and urgent care visits, maternity, durable medical equipment, rehabilitation, mental services, pediatric care, etc.); 2.) Cost-sharing limits including deductibles (notably medical, drug, equipment), out-of-pocket limits, the limitation on certain benefits (notably mental services, rehabilitation, and specialty drugs), and exclusions of key health services; 3.) The volume of the provider network, broken out by provider type (primary, specialist, hospital, medical group, etc.); 4.) The care and efficacy quality measures attached to the network and providers; 5.) The number of drugs contained in the formulary, and the availability of certain categories and notable drugs; 6.) optionally, an individual user's income information entered in connection with a healthcare subsidy inquiry.

Where information such as a consumer annual income is known and an inquiry into a potential subsidy may be made, the health insurance plan recommendation may take into account the subsidy. For example, the total cost of ownership may be adjusted to include this subsidy. The subsidy may be a government provided subsidy or provided from any other source. For example, employers could potentially provide subsidies for employees based on income.

Each component ranking may be determined by examining sub-components. In preferred embodiments, each sub-component is scored on a relative value basis (i.e. a>=b>=c for all possible values, where the scores are assigned either as a ordinal, binary, count, or real-valued score). These scores are then normalized based on the possible range of values in a linear or logarithmic method to produce (e.g. [max−min]/score). The following value sets now exists, and are able to be combined into category-component scores, for example:

As just one example, the category benefit scores may be determined by examining the following sub-components: 1.) Drug scores={brand_rx score, generic_rx score, nonpreferred_rx score, specialty_rx score, . . . }; 2.) Visit scores={primary_visit score, specialist_visit score, . . . }; 3.) Hospitalization scores={inpatient score}; and 4.) Any other scores for all relative benefit categories contained within plan set benefits.

As just one example, the cost-sharing component may be determined by examining the following sub-components: 1.) Deductible scores={medical_deductible score, brand_rx_deductible score, dme score, . . . }; and 2.) Out-of-pocket limits={oop_limit score, . . . }.

In some embodiments, the component network volume may be determined by examining the following sub-components: 1.) Providers score={primary_qty score, specialist_qty score, . . . }; 2.) Hospital score={hospital_qty score, . . . }; and 3.) any other categories of score.

In preferred embodiments, for each category (X), a weighted composite score is calculated based its sub-scores (i): For all scores in categoryX, categoryX_score=Σ score_i*weight_i, where weight_i is a vector which represents an assigned weight (importance) attached to a given score. A total score may now be produced by combining the category scores with the same method, where each category is assigned an importance weight, such as follows: For all category scores, total_score=Σ category_score_x*weight_x.

In preferred embodiments, the score may then be further personalized and re-weighted based on personal data captured from a user. This information may include, but is not limited to, the following types of data: demographics, current drug consumption (type and frequency), preferred doctors, disease or illness management, plan procedures, and planned visits to see specific providers.

Based on these inputs, the category specific baseline scores can be calibrated based on the user's inputs, using the following methods: 1.) Cost-drivers: if a user's specific medical or drug needs are much higher for specific categories, the assigned weights can be adjusted in-accordance with the users stated mix of needs. For example, if an individual sees an orthopedic specialist on a regular basis, a sum-part value can be calculated to determine how their visits to that specialist are relative to visits to other types of specialist. A weighting scheme that proportionally represents that user's office visit needs may be calculated, subsequently giving plans which provide better cost-value for the user a higher score. For example, an individual treating diabetes may have higher durable medical equipment costs than the average user. A total expected cost for procedures, visits, medical equipment, and drugs is calculated for a specific user, and then both category and sub-category cost-related scores are re-weighted to reflect the user's profile.

Provider network: 1.) A user may provide a list of preferred doctors, which are evaluated against the plan networks for inclusion or exclusion. The network category score is adjusted to include the proportion of in-network doctors for a specific user; and 2.) Based on the user's precise location (zip code or address based), the volume and quality scores can be adjusted based on a centered-radius from the user's location to give them a more relative score based on the providers and facilities that are near to them. The radius can be based on population (or provider) density or user-specified.

Demographic segmentation: a user's demographics, notably family status and age, allow for re-weighting based on expected out-of-pocket costs (typical lower costs for younger individuals, higher for older individuals), or for preference for pediatric services if there's a young child in the family.

User-preferences: Further, the user can state specific levels of preference which may be used to re-weight the baseline scores, including the convenience vs. cost, quality vs. cost, and convenience vs. quality. These preferences can be taken as ordinal or real-value numbers, and used to adjust both category and sub-category weights associated with cost (benefit values, premium, limits and exclusions), provider quality, and convenience (provider volume).

In some embodiments, a user may input information about medical procedures he or she may or will undertake during the time period specified for the aggregate cost estimate. In such embodiments, the Manager may consult the Plan Database to generate a revised aggregate cost estimate under each of the ranked plans displayed to the user and display the revised aggregate cost estimate associated with the particular procedure.

In some embodiments, the Interface display screen may include an expandable table of information about how each of a plurality of health plans pay for particular types of visit to a physician, which may include visits in emergency scenarios or other common types of physician visits. This table may be populated with metrics related to actual monetary cost, the percentage of the user's bill for the physician covered by the particular health plan, and/or the likelihood and/or cost of pre-deductible or post-deductible visits to such physicians.

In some embodiments, the Interface display may include an expandable display of information about how each of a plurality of health plans pays for all or a portion of certain prescription drugs. This expandable display may reflect brand name prescription drugs, generic prescription drugs, drugs specifically selected by a user for evaluation, other types of prescription medication costs associated with the plurality of health plans, or the cost of over-the-counter medications associated with the user's aggregate selections. For example, a consumer may be informed about how particular medical plans pay for blood test strips if either diabetes or a diabetes treating prescription is selected. The cost display may reflect a percentage of the total prescription drug cost covered by a particular health plan, may reflect a dollar amount a user must spend to purchase the normal dosage of such drugs under a particular health plan, and/or may be based on the pre-deductible, post deductible and/or payments associated with any of these.

In some embodiments, the Interface display may include an expandable display of information about how each of a plurality of health plans will pay for all or a portion of certain physician services. The display may reflect whether certain user-selected doctors will be within the network of a particular plan and therefore have “in-network” pricing. The display may also reflect whether you or the ranked plan will be permitted to choose which doctor you would visit for primary or other care. The display may also reflect how many physicians in a user's area are available for one or more kinds of care (i.e., primary care). The display may also reflect a quality assessment of the physicians in a given plan's network. Such quality assessment may be generated by the Plan Database, synthesized from publicly-available data, or both. In some embodiments, certain aspects of the Plan Database are housed on the user's client device in an alternative software format, and may be consulted and/or processed by a Manager to modify the display to the user through the Interface. In some embodiments, these display items may be present automatically in association with a recommendation, or may be truncated and expandable upon user request.

In some embodiments, after being presented with the opportunity to perform the above deep evaluation of health plan options, a user may be presented with an opportunity to purchase one of the ranked plans. The embodiments disclosed herein may permit the purchase of the previously-evaluated plan at the price calculated by clicking a hyperlinked button on the Interface. Provided users accurately enter basic demographic information about themselves and their families in the course of such evaluation, the premium estimates will be the actual premium. In some embodiments, the embodiments may verify that the user inputs are accurate with reference to information, data and/or software form an outside source.

In some embodiments, the embodiments may use the data collected from a user to apply for federal subsidies permitted under the Affordable Care Act or other legislation or tax credits under the Affordable Care Act or other legislation in connection with the purchase of health insurance. In some embodiments the user may be permitted to use the embodiments disclosed herein to calculate health insurance subsidies available to that user at any point during the evaluation process.

In some embodiments, users who purchase a plan using the tool may be offered refunds on a portion of premium or other payments for certain health-related milestones, which might include, without limitation, smoking cessation or other wellness targets.

As previously discussed, although most of the examples in this disclosure have focused on specific elements of health plan pricing and evaluation, the methods discussed herein may, in fact, be applied to other components of insurance pricing and/or other types of insurance, including without limitation life insurance, auto insurance, flood insurance, fire insurance, earthquake insurance, renter's insurance, or liability insurance.

Although the embodiments have been described with reference to preferred configurations and specific examples, it will readily be appreciated by those skilled in the art that many modifications and adaptations of the methods, processes and apparatuses disclosed herein are possible without departure from the spirit and scope of the embodiments as claimed hereinafter. Thus, it is to be clearly understood that this description is made only by way of example and not as a limitation on the scope of the embodiments.

What is claims is:

1. A method for transforming user data inputs into a health insurance plan recommendation comprising:
receiving user data inputs from a graphical user interface including location data, gender data, age data and smoking habits data;
determining a subset of available health insurance plans from a set of plans in a database based on the location data;
querying a second database for historical data records that match a subset of the user data inputs;
receiving health event data about a plurality of health events for each historical data record returned by the query;
calculating care cost for each health insurance plan in the subset of available health insurance plans by calculating costs associated with the health events under each health insurance plan in the subset of available health insurance plans;
calculating a total cost of ownership for each health insurance plan in the subset of available health insurance plans by adding monthly premiums for each health insurance plan in the subset of available health insurance plans to the care costs for that plan; and,
transmitting a health insurance plan recommendation based on the total cost of ownership to the graphical user interface.

2. The method of claim 1 wherein the health insurance recommendation is based exclusively on the total cost of ownership.

3. The method of claim 1 further comprising:
creating a plurality of weighted multipliers based on the user data inputs;
producing a plurality of category scores for categories including benefit levels, cost sharing, provider network volume, care and drug availability for each health insurance plan in the subset of available health insurance plans;
multiplying each category score by a weight multiplier from the plurality of weighted multipliers to produce weighted category scores;
multiplying the total cost of ownership by a weighted multiplier to produce a weighted total cost of ownership;
summing the weighted category scores and weighted total cost of ownership for each health insurance plan in the subset of available health insurance plans to produce a total weighted score; and,
transmitting the health insurance plan recommendation of the health insurance plan with the highest total weighted score.

4. The method of claim 1 further comprising, causing to be displayed on the graphical user interface the health insurance plan recommendation, the cost of care for that plan, and the premiums for that plan.

5. The method of claim 1 wherein the second database is comprised of a plurality of databases both public and private.

6. The method of claim 3 wherein the user data inputs further includes a supplemental user data input selected from the group consisting of medications currently taken, a desired doctor, and a current medical condition.

7. The method of claim 6 wherein the supplemental user data input is used to calculate at least one weighted multiplier.

8. The method of claim 1 wherein the user data input is data about a plurality of people in a family.

9. The method of claim 1 further comprising:
receiving data about a health scenario;
recalculating the care cost including the health scenario for each health insurance plan in the subset of available health insurance plans;
recalculating the total cost of ownership for each health insurance plan in the subset of available health insurance plans; and,
transmitting a new health insurance plan recommendation based on the recalculated total cost of ownership to the graphical user interface.

10. The method of claim 1 further comprising:
receiving a health insurance plan purchase request from a user; and,
enrolling the user in a selected health insurance plan.

11. A computer readable medium containing program instructions for providing a health insurance recommendation, wherein execution of the program instructions by one or more processors causes the one or more processors to carry out the method comprising:
receiving user data inputs from a graphical user interface including location data, gender data, age data and smoking habits data;
determining a subset of available health insurance plans from a set of plans in a database based on the location data;
querying a second database for database entries of people that match a subset of the user data inputs;
receiving health event data about a plurality of health events for each database entry returned by the query;
calculating care cost for each health insurance plan in the subset of available health insurance plans by calculating costs associated with the health events under each health insurance plan in the subset of available health insurance plans;
calculating a total cost of ownership for each health insurance plan in the subset of available health insurance plans by adding monthly premiums for each health insurance plan in the subset of available health insurance plans to the care costs for that plan; and,
transmitting a health insurance plan recommendation based on the total cost of ownership to the graphical user interface.

12. The computer readable medium of claim 11 wherein the health insurance recommendation is based exclusively on the total cost of ownership.

13. The computer readable medium of claim 11 wherein execution of the program instructions causes the one or more processors to carry out the method further comprising:
creating a plurality of weighted multipliers based on the user data inputs;
producing a plurality of category scores for categories including benefit levels, cost sharing, provider network volume, care and drug availability for each health insurance plan in the subset of available health insurance plans;
multiplying each category score by a weight multiplier from the plurality of weighted multipliers to produce weighted category scores;
multiplying the total cost of ownership by a weighted multiplier to produce a weighted total cost of ownership;
summing the weighted category scores and weighted total cost of ownership for each health insurance plan in the subset of available health insurance plans to produce a total weighted score; and,
transmitting the health insurance plan recommendation of the health insurance plan with the highest total weighted score.

14. The computer readable medium of claim 11 wherein execution of the program instructions causes the one or more processors to carry out the method further comprising: causing to be displayed on the graphical user interface the health insurance plan recommendation, the cost of care for that plan, and the premiums for that plan.

15. The computer readable medium of claim 11 wherein the second database is comprised of a plurality of databases both public and private.

16. The computer readable medium of claim 15, wherein the user data inputs further includes a supplemental user data input selected from the group consisting of medications currently taken, a desired doctor, and a current medical condition.

17. The computer readable medium of claim 16, wherein the supplemental user data input is used to calculate at least one weighted multiplier.

18. The computer readable medium of claim 11, wherein the user data input is data about a plurality of people in a family.

19. The computer readable medium of claim 11 wherein execution of the program instructions causes the one or more processors to carry out the method further comprising:
receiving data about a health scenario;
recalculating the care cost including the health scenario for each health insurance plan in the subset of available health insurance plans;
recalculating the total cost of ownership for each health insurance plan in the subset of available health insurance plans; and,
transmitting a new health insurance plan recommendation based on the recalculated total cost of ownership to the graphical user interface.

20. The computer readable medium of claim 11 wherein execution of the programs instructions causes the one or more processors to carry out the method further comprising:
receiving a health insurance plan purchase request from a user; and,
enrolling the user in a selected health insurance plan.

21. A system for recommending a health insurance plan comprising:
a graphical user interface for receiving user data inputs including location data, gender data, age data and smoking habits data;
a database comprising data about a plurality of health insurance plans;
a first server running software executed by a processor designed to perform the method comprising:
determining a subset of available health insurance plans in the database based on the location data received from the graphical user interface;
querying a second database for database entries of people that match a subset of the user data inputs;
receiving health event data about a plurality of health events for each database entry returned by the query;
calculating care cost for each health insurance plan in the subset of available health insurance plans by calculating costs associated with the health events under each health insurance plan in the subset of available health insurance plans;
calculating a total cost of ownership for each health insurance plan in the subset of available health insurance plans by adding monthly premiums for each health insurance plan in the subset of available health insurance plans to the care costs for that plan; and,
transmitting a health insurance plan recommendation based on the total cost of ownership to the graphical user interface.
